(19) United States
(12) Patent Application Publication
(10) Pub. No.: US 2013/0117193 A1
(43) Pub. Date: May 9, 2013

(54) Goods delivery demand and supply mating system and method thereof

(71) Applicant: CHUN KAI NI, TAIPEI (TW)

(72) Inventor: CHUN KAI NI, TAIPEI (TW)

(21) Appl. No.: 13/668,221

(22) Filed: Nov. 3, 2012

(30) Foreign Application Priority Data
Nov. 4, 2011 (TW) 100220952

(51) Int. Cl. G06Q 10/08

(52) U.S. Cl. 705/334

(57) ABSTRACT

A goods delivery demand and supply mating system, which includes a goods delivery demand module, a goods delivery supply module and a data processing unit. The goods delivery demand module is for receiving at least one goods delivery demand order. The goods delivery supply module is for receiving at least one goods delivery supply order. The data processing unit connects to the goods delivery demand module and goods delivery supply module, and performs a mating process upon the goods delivery demand order and the goods delivery supply order to to find out a compatibility and generate a mating result base on the compatibility.

### FIELD OF THE INVENTION

The present invention relative to a goods delivery system, particularly to a goods delivery demand and supply mating system and method thereof.

### BACKGROUND

The rise of environmental awareness in recent years with the rapid oil prices soaring, driven by the trends of the global carbon reduction. The transportation burning fossil fuels that causes carbon dioxide emission has become one of the major reasons of global warming.

With the prevalence of global trade and transportation demand growth with the logistics industry scale rising, the energy consumption and emissions of greenhouse gases has increased year by year. In order to reduce carbon emissions and meet growing goods delivery demand, a more economic and efficient goods delivery system, is eagerly anticipated.

The conventional model of goods delivery, simply implemented by point-to-point transportation by sea, air or land traffic, and may be of various types of manners including courier, mail, home delivery . . . etc.

Moreover, the conventional goods delivery system operated under organized units or inflexible business entities, and requires personnel training, equipment maintenance or energy supply. With all required conditions well set, the system then can perform goods delivery well. Even more, goods delivery system operators have to invest a lot of money and input a lot of human power to keep a smooth operation.

The conventional mailing delivery service is widely used for normal goods delivery. To mailing delivery an item, a delivery demander takes his/her goods to a service center or a goods gathering point, such as the Post Office for delivery. In said places, those items are centralized for transferring to a destination. Unlike to the mail delivery service, the “Express delivery service” like UPS, DHL, provides a specific delivery service. It provides a rapid goods delivery service for people who are in rush. But it requires highly charge and is not preferred for delivery unimportant items, or items of little value.

In any case, regardless of their difference, aforesaid manners are all requires highly frequent delivery traffic. At least, a goods centralization process is needed and is requiring a lot of unnecessary transportation that seriously causes huge energy consumption.

The aforementioned conventional goods delivery services, particularly, is not suitable for short-distanced or small weighted or small volume item's delivery. Thus, in such demand, people mostly would rather to deliver them by themselves and on their own ride, traffic by bus, taxi, bicycle . . . or other means. To people, the traffic is tedious, uneconomic yet inevitable. Such repeated piecemeal and fragmental goods delivery traffic consumes huge resource or energy and generates a lot of greenhouse gas, and result in lower goods delivery efficiency and less favorable environmental protection.

Specifically, delivering little valued items like greeting cards, books or pens in a short distance, by means of Express or home delivery, would be very uneconomical. Although several existing goods delivery services like bicycle delivery claims that saving energy consumption and is cheap, however, long delivery time and inconvenience are still criticized.

More importantly, for environmental considerations, conventional goods delivery system consumes energy in a large scaled, repeated and uneconomic way that causes huge carbon emission. Although the industry still strive to make a good operation model that minimize the consumption, but in long term, there is nothing can be changed under conventional goods delivery model. It's foreseeable, with goods delivery demand increased in the future, massive vehicles performing goods delivery will keep a huge carbon emission and cause an irreversible damage to the natural environment.

Therefore, it is urgently requires a system, which provides an extraordinary manner differing from conventional logistics transportation models, to reduce overall time, distance and cost of good delivery transportation, and with more efficiency and convenience, to improve environment protection.

### Some Exemplary Embodiments

In view of the above problems, an object of the present invention is to provide a goods delivery demand and supply mating system and method thereof, which can provide a fast mating between goods delivery demands and supplies. The present invention differs from conventional goods delivery models, may avoid piecemeal and fragmental goods delivery traffic to improve goods delivery efficiency and reduces time wasted for goods centralization process, and provides flexibility for goods delivery.

Another objective of present invention is to provide a mating system and method thereof, to develop a platform for goods delivery information exchange, thereby fulfill the goods delivery demands by combination of daily commute of people or units. The present invention allows rapid, cheap and economic goods delivery, more important, eliminate energy consumption by integrating goods delivery into necessary traffic, e.g. people's daily commuting.

Therefore, the present invention develops a new goods delivery model that is different from conventional models. Which not only resolve pollutions caused by frequent and repeated transportation, but also free from goods centralization and storage management and thus reduces operation cost.

Even more, with present system or method of the invention, a cheaper goods delivery fee is charged, in case an delivery supplier carries multiple demander's goods to the same one destination.

To achieve above objectives, according one embodiment of the present invention, a goods delivery demand and supply mating system comprises a goods delivery demand module, a goods delivery supply module and a data processing unit.

The goods delivery demand module and goods delivery supply module may be combined with one data processing unit, or, respectively cooperated with multiple data processing unit in different hosts.

The goods delivery demand module has an delivery demander interface for receiving at least one goods delivery demand order, and the goods delivery supply module may has a delivery supplier interface. The delivery demander interface and the delivery supplier interface can be of the same interface, or seperated.

The data processing unit is connected to the goods delivery demand module and the goods delivery supply module, which receives at least one goods delivery demand order and goods delivery supply order and performs a mating process upon the goods delivery demand order and goods delivery supply order that determining a compatibility thereof, and generates at least one mating result.

Otherwise, to achieve above objectives, according to one embodiment of present invention, a goods delivery demand and supply mating method may apply on above mentioned goods delivery demand and supply mating system, the method comprises steps of: receiving at least one goods delivery demand order by a goods delivery demand module; receiving at least one goods delivery supply order by a goods delivery supply module; performing a mating process upon the goods delivery demand order and goods delivery supply order that determining a compatibility thereof; and generates at least one mating result.

Accordingly, the goods delivery demand and supply mating system develops a platform for mating goods delivery demands and goods delivery supplies, and is suitable for mating goods delivery demands and supplies from remote terminals, e.g. websites presented on personal computers.

With such, the goods delivery demand and supply mating system and method thereof of the present invention created a different goods delivery system, which is distinguished from conventional goods delivery systems, avoids centralization process of goods and shipping that caused time delay. The system or method of the invention is suitable for delivery of small weighted, volumed or little-valued items. The system or method of the invention utilizes motorized traffic supplies from people who commute and willing to provide goods delivery services. For goods delivery demanders, he/she don't have to wait for the trucking companies or to send goods to a delivery service center, and can enjoy a rapid and economic resolution from the system of the invention. Thereby, the invention improves the efficiency of goods delivery, reduce the time wasting, or spend, cost and resource consumption for transportation.

With the concept of “take the opportunity to bring”, the present invention integrates goods delivery transportation into necessary daily traffic, effectively reduces energy consumption that emits greenhouse gas, to balance economic development and environmental protection.

### BRIEF DESCRIPTION OF THE DRAWINGS

FIG. 1 is a block diagram according to a preferred embodiment of the goods delivery demand and supply mating system of the invention;

FIG. 2 is a block diagram according to an another preferred embodiment of the goods delivery demand and supply mating system of the invention;

FIGS. 3A to 3E are schematic diagrams showing mating results in different cases;

FIG. 4 is a block diagram according to a further embodiment of present invention; and

FIG. 5 is a block diagram illustrating the goods delivery demand and supply mating method of a preferred embodiment of the invention.

### DESCRIPTION OF THE PREFERRED EMBODIMENT

With according to the drawings, which illustrates preferred embodiments of the goods delivery demand and supply mating system and method thereof in accordance with present invention. The same components or steps therein will refer to the same numbers in the drawings.

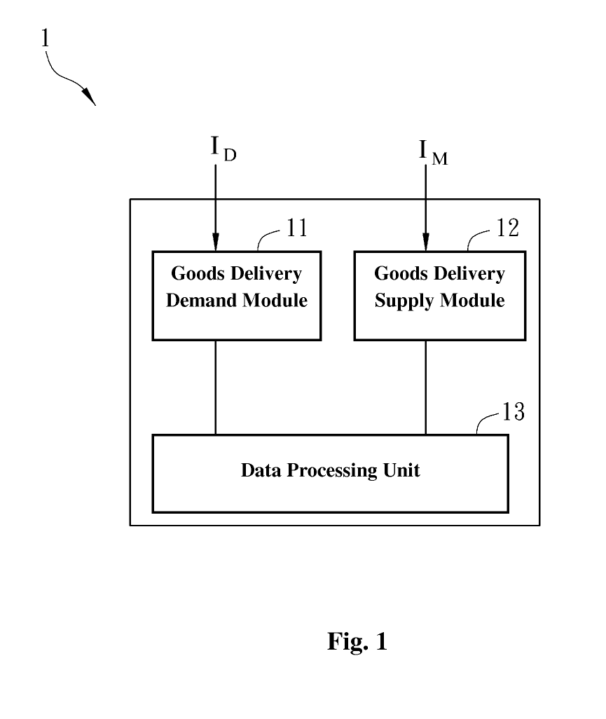

FIG. 1 is a block diagram according to a preferred embodiment of the goods delivery demand and supply mating system in accordance with the present invention. The goods delivery demand and supply mating system comprises a goods delivery demand module 11, a goods delivery supply module 12 and a data processing unit 13. First of all, it is noted that the goods delivery demand and supply mating system of the invention, may be constructed in for example but not limited thereto: a server, a computer or an electronic device with digital data exchange and calculating function. Preferably, the goods delivery demand and supply mating system is constructed in a remote server. The term “remote” means implemented apart from end users, not for limiting in locations. The goods delivery demand and supply mating system may utilize a website, computer program or platforms in various styles for realization. Otherwise, mentioned goods delivery demander and goods delivery supplier are not limited in forms, preferably may be users who implementing the goods delivery demand and supply mating system, or companies, organizations. For example, the goods delivery supplier can be a truck driver who are about to drive from A place to B place, whether with carrying cargo or not, the goods delivery demander can be an online shopping business entity which needs delivery goods to B place. Preferably, the goods delivery suppliers are identified and qualified by the system of present invention, or by the goods delivery demanders.

The goods delivery demand module 11 is for receiving at least one goods delivery demand order I_{D}. The goods delivery supply module 12 is for receiving at least one goods delivery supply order I_{M}. In present embodiment, the goods delivery demand module 11 comprises a delivery demander interface, the delivery demander interface is constructed by an inner process unit, a storage unit, a data receiving unit and/or other components of the goods delivery demand and supply mating system. The delivery demander interface allows the goods delivery demander, via an electronic device thereof, remotely connects to the system of the invention and inputs a goods delivery demand order I_{D}. It is noted, the present invention do not limit the manner of mentioned connection between the electronic device and the system of the invention. The connection may via wire or wireless manner. The wire manner includes but not limited to Fiber-optic communication or Coaxial cable communication. The wireless manner includes but not limited to GPRS, GSM, WIFI or Bluetooth transmission.

In presented embodiment, the goods delivery demand order I_{D} includes at least one of following: a time data, a location data, a budget data, an evaluation data, a criterion data or a goods information. Among which, the time data may be a time period, which includes but not limited to the time that the goods should be delivered, the time that the goods should be arrived, or the time period that goods delivery is required. The location data may include but not limited to the place or location that the goods are provided, the destination that the goods intend to go, or the route to take. The budget data may include but not limited to a cost that demander is affordable for the goods delivery. The criterion data may include but not limited to a demander's predetermined criterion for the suppliers such as age, occupation, sex, education . . . etc., or criterions for quality or evaluation of goods delivery suppliers, or for required transportation means such as MRT, cars, buses, trucks, motorcycles, bicycles or Frozen container trucks. The goods information may include but not limited to details about the goods, such as what's the goods, being fragile or not, needing be frozen or not, or volume, weight, content of the goods . . . etc.

The goods delivery supply module 12 may comprises a delivery supplier interface, which may be constructed by internal data processing units, storage units, data receiving units and/or other components of the goods delivery demand and supply mating system. The delivery supplier interface may be displayed on an electronic device, e.g. computers or mobile phones, which connected with the system of present invention and allows a goods delivery supplier to operate and input a goods delivery supply order I_{M}. It is noticed that the goods delivery demand module 11 mentioned here, could be different from the goods delivery supply module 12 in function thereof, but may be the same in physical structure, or may be substantially integrated in one device which provides both of functions of the goods delivery demand module 11 and the goods delivery supply module 12. In such a case, the operation of those components in the system of present invention should not be limited. For example, one data process unit and storage unit may both handles data from the delivery demander interface and delivery supplier interface.

In presented embodiment, the goods delivery supply order I_{M} includes at least one of following: a time data, a location data, a route data, a fee data, an evaluation data, a criterion data or a quantity data. Among which, the time data may be a time period, which includes but not limited to a departing time or an available delivery service time, or a customary commuting time. The location data may include but not limited to a place to receive the goods, an intermediate place to stop, a destination about to go and/or a preset goods centralization place. The route data may include but not limited to the route that the supplier supposed to take. The fee data may include but not limited to a fee that the supplier required for his/her delivery service. The evaluation data may include but not limited to an evaluation upon a served goods delivery demander. The criterion data may include but not limited to criterions for substance of goods, or for predetermined evaluation of goods delivery demander. The quantity data may include but not limited to an amount of the goods, or a volume or weight of the goods that the supplier are willing to deliver.

Of cause, above mentioned contents regarding to the goods delivery demand order I_{D} and the goods delivery supply order I_{M} are intended to be illustrative and not restrictive. Other data or information that are required or input are intended to be embraced within the scope of embodiments of the present invention, such as personal information of the goods delivery demander or supplier, or any other comment or note.

In any case, it is understood that the delivery demander interface of the goods delivery demand module 11 is physically or visually defined with input units like buttons, blanks or tables for receiving the time data, the location data, the budget data, the evaluation data, the criterion data or the goods information that constructed said goods delivery demand order I_{D}. Likewise, the delivery supplier interface is defined with input units like buttons, blanks or tables for receiving the time data, the location data, the route data, the fee data, the evaluation data, the criterion data or the quantity data that constructed said goods delivery supply order I_{M}.

The data processing unit 13 is connected between the goods delivery demand module 11 and the goods delivery supply module 12, receives and processes a programmable logic mating process upon the goods delivery demand order I_{D} and the goods delivery supply order I_{M}, and generates a mating result.

Aforementioned mating process, generally includes: transferring the goods delivery demand order I_{D} and the goods delivery supply order I_{M} into essentially comparable digital data; comparing the goods delivery demand order and the goods delivery supply order, in such digital data manner, with each other or with a reference data; calculating with data processing methodology or statistic methodology to find out a compatibility and generating the mating result base on the compatibility. Said compatibility may be data similarity or an accommodation between time data and location data of the goods delivery demand order and the goods delivery supply order. Notely, the displayed mating result may contains a user suggestion that facilitates receiving and/or delivering goods for the goods delivery supplier's reference.

The data processing methodology or statistic methodology, to those who are skilled in the art, is obvious from present computer science or digital data processing technology, and are not further illustrated herein.

Preferably, in an exemplary embodiment, the goods delivery demand order I_{D} and the goods delivery supply order I_{M} that match in the time data, are transferred into dots or lines of different groups that comprises geographic information in a referenced map pattern. Respectively compares those dots or lines groups on the referenced map pattern. If the dots or lines are match, generates a mating result that describes such match and combination. Any other statistic methodology that involve in data comparison are also implementable.

The mating result, essentially may be presented in manners of words, figures, images, voice or any multimedia style for informing the goods delivery demander or supplier that a compatibility is exist between the goods delivery demand order and goods delivery supply order thereof.

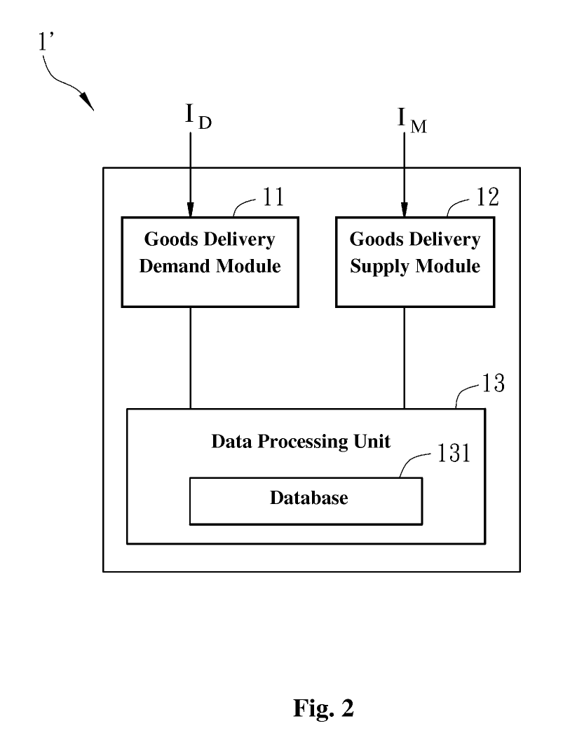

Furthermore, the data processing unit 13 may display the mating result in manners like an notice information on the electronic device for the goods delivery demander or the goods delivery supplier, i.e. on the delivery demander interface or the delivery supplier interface. With reference to FIG. 2, in another embodiment of the invention, the data processing unit 13 further comprises a database 131, which stores the goods delivery demand order I_{D} and/or goods delivery supply order I_{M} and the mating result.

Of cause, the goods delivery demand and supply mating system of present invention may apply on a mass of demanders and suppliers and performs an instant and real time mating process. As such, please refer to FIG. 2, the goods delivery demand and supply mating system 1′ receives a plurality of the goods delivery demand order I_{D} and goods delivery supply order I_{M} via the goods delivery demand module 11 and the goods delivery supply module 12. Then stores the plurality of the goods delivery demand order I_{D} and goods delivery supply order I_{M} in the database 131. When new goods delivery demand order I_{D} or goods delivery supply order I_{M} is received, the data processing unit performs a real time mating process to generate a mating result.

However, the term “real time” is not intended to constrict the manner that the mating process performed. In other manner, such as regularly perform the mating process by predetermined time interval is also achievable.

It's noticed that the style of the mating result includes but not limited to a table containing one or more mated subject for the goods delivery demander to choose therefrom, or to input further criterion for next mating process. For example, in one embodiment of present invention, the mating result for a goods delivery demander may include a table listing goods delivery suppliers providing accommodating goods delivery supply order I_{M}. Preferably, the goods delivery demander may, or the goods delivery supplier, may set predetermined priority conditions for the mating result, such as, while in situation of multiple mated subjects, arranges the mated subjects according to their required fee for goods delivery service.

Oppositely, for goods delivery suppliers, the mating result may include but not limited to a table containing one or more mated subject for the goods delivery supplier to choose therefrom, or to input further criterion for next mating process. Accordingly, the goods delivery supplier, may set predetermined priority conditions for the mating result.

Otherwise, the data processing unit 13 may be processed based on a map or a navigation information stored in the database 131 to generate a user suggestion included in the mating result to facilitate receiving and/or delivering goods for the goods delivery supplier's reference. The user suggestion may have a suggested route for the goods delivery supplier's reference to receive and/or deliver goods. By the suggested route, additional benefit is acquired or unnecessary spend due to extra traffic is avoided.

Furthermore, the user suggestion may comprise at least one of a distance-optimization information, a time-optimization information or a cost-optimization information.

The distance-optimization information suggests a shortest distance for goods delivery suppliers to get and/or to deliver the goods. The time-optimization information suggests a fastest or smoothest route for goods delivery suppliers to get and/or to deliver the goods. The cost-optimization information suggests a most economic transportation or traffic for goods delivery suppliers to get and/or to deliver the goods, so as to avoid unnecessary spend due to extra traffic, or to gather as much goods as possible during the move.

With reference to some illustrative examples as follow, the skilled in the art is believed to be better understood the spirit and scope of present invention.

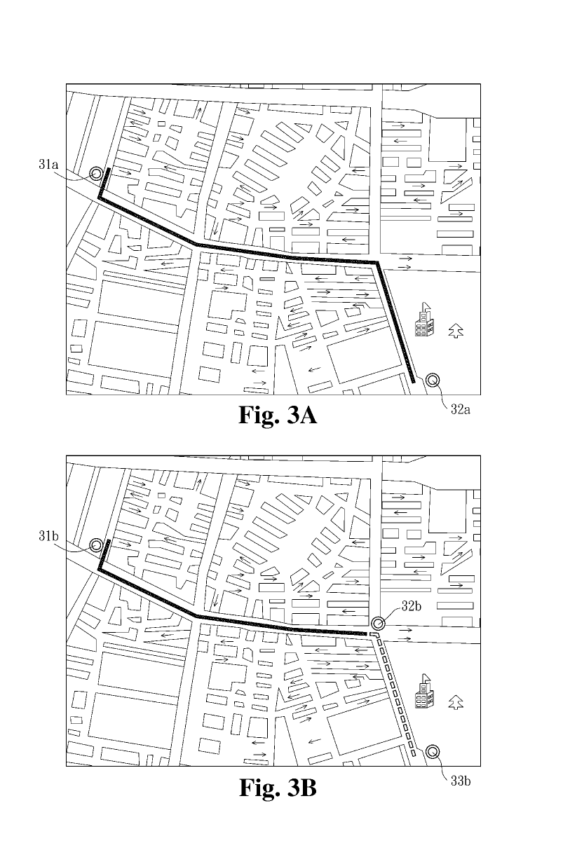

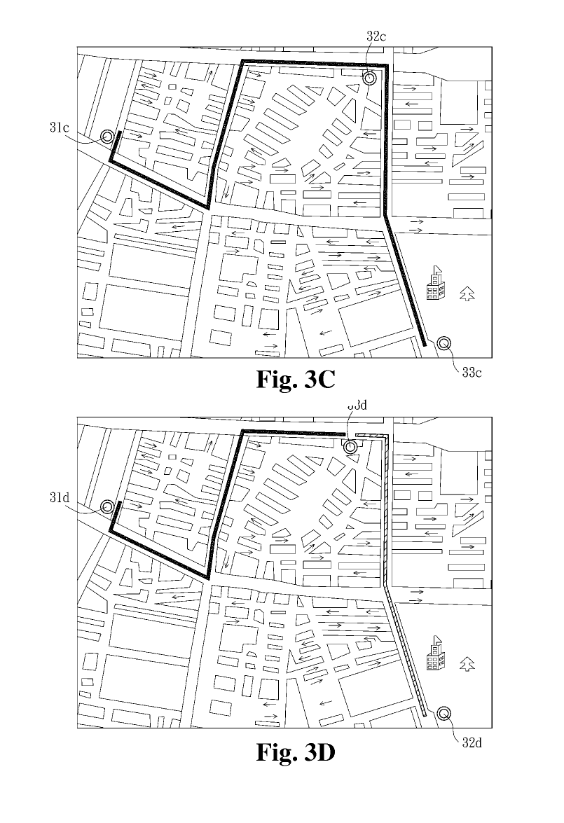

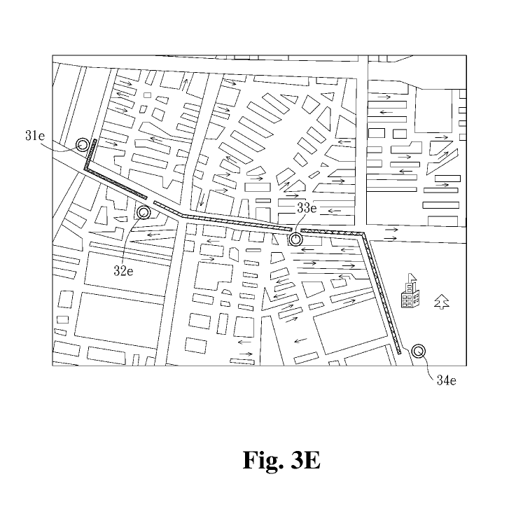

FIG. 3A to FIG. 3E is a preferred embodiment according to the invention, which illustrates mating results in different purpose. Each of the FIG. 3A to FIG. 3E is presented in manner of lines generated on a referenced map pattern according to the mating result. As shown in FIG. 3A, in this case, a goods delivery demander want to deliver his/her goods from a first place 31a, or place nearby the first place 31a (generally referred as the first place 31a in the follow), to a second place 32a, or place nearby the second place 32a (generally referred as the second place 32a in the follow), and input a goods delivery demand order I_{D} to the mating system of the invention. Meanwhile, a goods delivery supplier is about to move from the first place 31a to the second place 32a, and input a goods delivery supply order I_{M} to the mating system of the invention. The data processing unit performs a mating process upon the goods delivery demand order I_{D} and the goods delivery supply order I_{M}. Once the data processing unit finds out a compatibility between the goods delivery demand order I_{D} and the goods delivery supply order I_{M}, the data processing unit generates a mating result and display the mating result on the delivery demander interface and delivery supplier interface. The mating result provides a suggested route for the goods delivery supplier's reference to receive and/or deliver goods, so as to avoid unnecessary spend due to extra traffic.

With reference to FIG. 3B, in this case, a goods delivery demander want to deliver his/her goods from a first place 31b to a second place 32b. Meanwhile, a goods delivery supplier is about to commute from the first place 31b to a third place 33b, and will pass by the second place 32b in his midway.

The data processing unit performs a mating process upon the goods delivery demand order I_{D} and the goods delivery supply order I_{M} input by the delivery demander and the delivery supplier. Once the data processing unit finds out a compatibility between the goods delivery demand order I_{D} and the goods delivery supply order I_{M}, the data processing unit generates a mating result and display the mating result on the delivery demander interface and delivery supplier interface. The mating result contains the user suggestion that reminds the delivery supplier to complete his/her job of delivering the goods in the midway, i.e. the second place 32b, to fulfill the demander's anticipation.

With reference to FIG. 3C, in this case, a goods delivery demander wants to deliver goods from a first place 31c to a second place 32c. A goods delivery supplier, during a time, is leaving a first place 31c and goes to a third place 33c.

The data processing unit performs a mating process upon the goods delivery demand order I_{D} and the goods delivery supply order I_{M} input by the delivery demander and the delivery supplier.

Though the delivery supplier does not pass by the second place 32c, but determining among those other goods delivery supply order in the database 131, the second place 32c is nearest to the third place 33c, or the second place 32c is nearest to a midway between the first place 31c and the third place 33c, the data processing unit generates a mating result and display the mating result on the delivery demander interface and delivery supplier interface. The mating result contains a user suggestion for the delivery supplier to modify his/her route for facilitating completion of the goods delivery. The user suggestion provides a suggested route. As can be seen, the suggested route from the first place 31c to the third place 33c extends to cover the second place 32c. With such, additional benefit is acquired or unnecessary spend due to extra traffic is avoided

With reference to FIG. 3D, in this case, a goods delivery demander want to deliver his/her goods from a first place 31d to a second place 32d, and a first goods delivery supplier is about to travel from the first place 31d to a third place 33d during a predetermined time. The first delivery supplier's route does not pass by the second place 32d. However, during the predetermined time, a second goods delivery supplier is about to travel from the third place 33d to the second place 32d. In this condition, the data processing unit performs a mating process upon the goods delivery demand order I_{D} and the goods delivery supply order I_{M} input by the delivery demanders and the delivery suppliers. Once the data processing unit finds out a compatibility between the goods delivery demand order I_{D} and the goods delivery supply order I_{M}, The data processing unit generates a mating result. The mating result contains a suggestion for the delivery suppliers to co-work by relaying the goods in different sections in the route. Of cause, it's not limited in two delivery suppliers, three, four, five or more delivery supplier can work under this model.

With reference to FIG. 3E, in this case, a first goods delivery demander wants to deliver his/her goods from a first place 31e to a second place 32e. Additionally, a second goods delivery demander wants to deliver his/her goods from the second place 32e to a fourth place 34e, and a third goods delivery demander want to deliver his/her goods from a third place 33e to the fourth place 34e. Meanwhile a goods delivery supplier is about to travel from the first place 31e to the fourth place 34e.

The data processing unit performs a mating process upon the goods delivery demand order I_{D} and the goods delivery supply order I_{M} input by the delivery demanders and the delivery supplier. Once the data processing unit finds out a compatibility between the goods delivery demand order I_{D} and the goods delivery supply order I_{M}, The data processing unit generates a mating result and displays the mating result.

The mating result contains a suggestion for the delivery supplier to contact and receive goods from the first, second and third goods delivery demanders respectively at the first place 31e, the second place 32e and the third place 33e, and delivers the goods to the fourth place 34e at once. In this manner, goods delivery efficiency is apparently enhanced, additional benefit is acquired.

In more detail, the system of the invention may provide profiles or contact information about mated goods delivery suppliers or demanders, so as to facilitate contact or communication between both parties. Furthermore, may also provide determined goods arriving time to people who may concern.

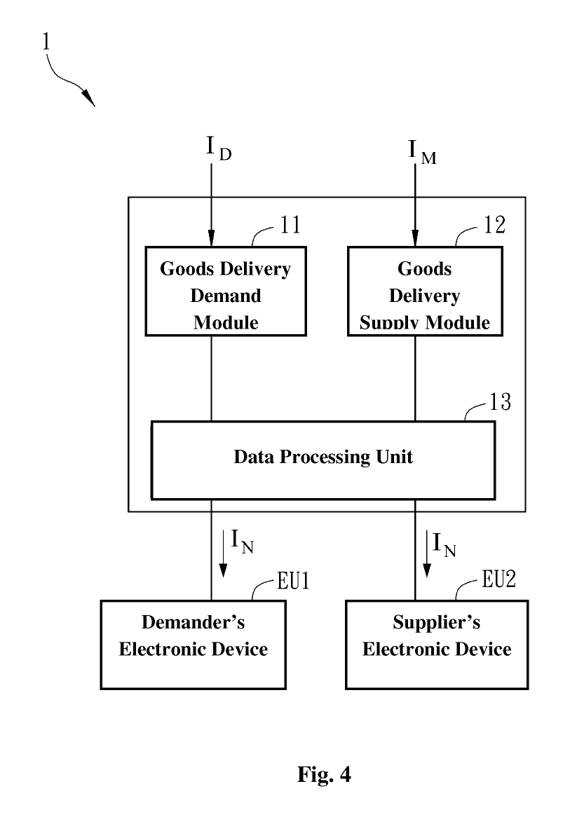

In a preferred embodiment, the data processing unit 13 of the goods delivery demand and supply mating system displays the mating result on a web site or computer software interface. Besides, as shown in FIG. 4, the data processing unit 13 may transfer a notice information I_{N} that according to the mating result to an electronic device EU1 of a mated delivery demander and/or an electronic device EU2 of a mated delivery supplier. In detail, as said above, once a mating result is generated, the goods delivery demander or supplier may receive a notice information I_{N} on his/her electronic device EU1, EU2(such as a tablet personal computer or a smart phone), to know relevant information about mating result, like goods delivery supplier profile, contact, cost or determined goods arriving time. Furthermore, the goods delivery demander or supplier may reply to the notice information I_{N} for making sure a permit to the goods delivery, or making a payment.

In a further embodiment, once multiple different goods delivery demander reply to the notice information I_{N} are concentratedly located in a predetermined area, the data processing unit 13 may calculate and provide a fee discount massage to those delivery demanders, so as to encourage a concentration for goods and avoid unnecessary traffic for gathering those goods. The fee discount rate may depend on the numbers of goods, i.e. the more number the higher discount rate.

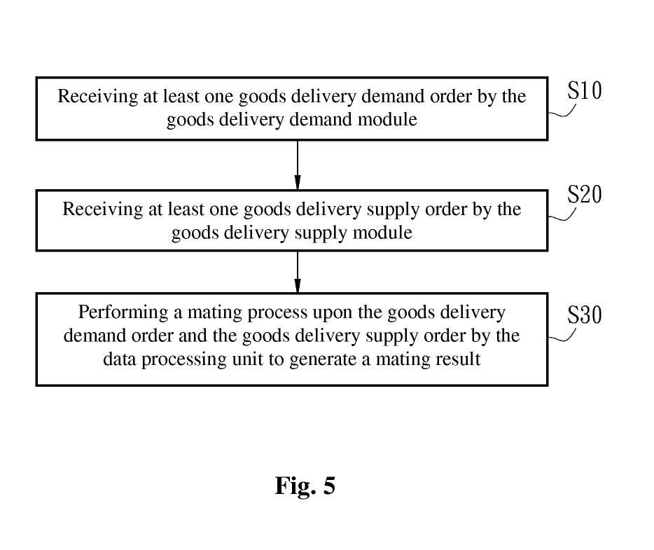

With further reference to FIG. 5 that illustrates a goods delivery demand and supply mating method in accordance with the invention. The method of the invention preferably applies to the goods delivery demand and supply mating system of the invention. As above mentioned, the goods delivery demand and supply mating system comprises a goods delivery demand module, a goods delivery supply module and a data processing unit. The goods delivery demand and supply mating method comprises steps S10˜S30 as follow. In step S10: receiving at least one goods delivery demand order by the goods delivery demand module. In step S20: receiving at least one goods delivery supply order by the goods delivery supply module. In step S30: performing a mating process upon the goods delivery demand order and the goods delivery supply order by the data processing unit to generate a mating result.

Since the feature or application of the steps of the method are illustrated in foregoing embodiments, persons who skilled in the art is believed to understood by those detailed illustration, and additional explanation shall not be recited hereinafter.

Accordingly, the goods delivery demand and supply mating system develops a platform for mating goods delivery demands and goods delivery supplies, and is suitable for mating goods delivery demands and supplies from remote ends of websites.

With such, the goods delivery demand and supply mating system and method thereof of the present invention created a different goods delivery system, which is distinguished from conventional goods delivery systems, avoids centralization process of goods and shipping that caused time delay. The system or method of the invention is suitable for delivery of small weighted, volumed or little-valued items. The system or method of the invention utilizes motorized traffic supplies from people who commute and willing to provide goods delivery services. For goods delivery demanders, he/she don't have to wait for the trucking companies or to send goods to a delivery service center, and can enjoy a rapid and economic resolution from the system of the invention. Thereby, the invention improves the efficiency of goods delivery, reduce the time wasting, or spend, cost and resource consumption for transportation.

With the concept of “take the opportunity to bring”, the present invention integrates goods delivery transportation into necessary daily traffic, effectively reduces energy consumption that emits greenhouse gas, to balance economic development and environmental protection.

It's noticed that the goods delivery demand and supply mating system and method thereof of the invention is not only suitable for individual delivery demanders or suppliers, but also for large sized business entities. With present invention, large sized business entities carry out their logistics in a rapid, flexible and economic way that saves time or cost that originally spent on goods centralization or storing.

While embodiments of the present invention have been disclosed in exemplary forms, it will be apparent to those skilled in the art that many modifications, additions and deletions can be made without departing from the spirit and scope of the inventor and its equivalents as set forth in the following claims.

The components and materials described hereinafter as making up the various embodiments are intended to be illustrative and not restrictive. Many suitable components and materials that would perform the same or a similar function as the materials described herein are intended to be embraced within the scope of embodiments of the present invention.

What is claimed is:

1. A goods delivery demand and supply mating system, comprises:
a goods delivery demand module for receiving at least one goods delivery demand order, the goods delivery demand order comprises a time data, a location data and a goods information;
a goods delivery supply module for receiving at least one goods delivery supply order, the goods delivery supply order comprises a time data, a location data and a route data; and
a data processing unit connected to the goods delivery demand module and the goods delivery supply module and performing a mating process upon the goods delivery demand order and the goods delivery supply order to to find out a compatibility and generate a mating result base on the compatibility.

2. The goods delivery demand and supply mating system as claimed in claim 1, wherein the goods delivery demand module further comprises a delivery demander interface having input units to receive the goods delivery demand order.

3. The goods delivery demand and supply mating system as claimed in claim 1, wherein the goods delivery supply module further comprises a delivery supplier interface having input units to receive the goods delivery supply order.

4. The goods delivery demand and supply mating system as claimed in claim 1, wherein the data processing unit presents the mating result in manners of an notice information on the goods delivery demand module and the goods delivery supply module.

5. The goods delivery demand and supply mating system as claimed in claim 1, wherein the mating result contains a user suggestion.

6. The goods delivery demand and supply mating system as claimed in claim 5, wherein the user suggestion provides a suggested route.

7. The goods delivery demand and supply mating system as claimed in claim 6, wherein the user suggestion further comprises a distance-optimization information, a time-optimization information or a cost-optimization information.

8. The goods delivery demand and supply mating system as claimed in claim 1, wherein the goods delivery demand order further comprises a budget data, an evaluation data or a criterion data.

9. The goods delivery demand and supply mating system as claimed in claim 1, wherein the goods delivery supply order further comprises a fee data, an evaluation data, a criterion data or a quantity data.

10. The goods delivery demand and supply mating system as claimed in claim 1, wherein the data processing unit further calculates and provides a fee discount massage.

11. The goods delivery demand and supply mating system as claimed in claim 1, wherein the data processing unit further comprises a database storing the goods delivery demand order, the goods delivery supply order and the mating result.

12. A goods delivery demand and supply mating method applying to a goods delivery demand and supply mating system comprising a goods delivery demand module, a goods delivery supply module and a data processing unit connected to the goods delivery demand module and the goods delivery supply module, the steps of the method includes:
receiving at least one goods delivery demand order by the goods delivery demand module;
receiving at least one goods delivery supply order by the goods delivery supply module; and
performing a mating process upon the goods delivery demand order and the goods delivery supply order by the data processing unit to find out a compatibility and generate a mating result base on the compatibility.

13. The method as claimed in claim 12, wherein the generated mating result is displayed as an notice information.

14. The method as claimed in claim 12, wherein the generated mating result further comprises an user suggestion providing a suggested route.

15. The method as claimed in claim 14, wherein the user suggestion further comprises a distance-optimization information, a time-optimization information or a cost-optimization information.

16. The method as claimed in claim 12, wherein the goods delivery demand order further comprises a budget data, an evaluation data or a criterion data.

17. The method as claimed in claim 12, wherein the goods delivery supply order comprises a fee data, an evaluation data, a criterion data or a quantity data.

18. The method as claimed in claim 12, further comprises calculating and provide a fee discount massage by the data processing unit.

19. The method as claimed in claim 12, wherein mating process comprises steps of:
transferring the goods delivery demand order and the goods delivery supply order into essentially comparable digital data;
comparing the goods delivery demand order and the goods delivery supply order;
calculating to find out a compatibility between the goods delivery demand order and the goods delivery supply order; and
generating the mating result base on the compatibility.
